(19) United States
(12) Patent Application Publication
(10) Pub. No.: US 2007/0263028 A1
(43) Pub. Date: Nov. 15, 2007

(54) Droplet discharge apparatus

(75) Inventors: Takeshi Zengo, Kanagawa (JP); Masahiko Sekimoto, Kanagawa (JP); Satoshi Mohri, Kanagawa (JP); Toru Nishida, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/585,568

(22) Filed: Oct. 24, 2006

(30) Foreign Application Priority Data
May 15, 2006 (JP) 2006-135173

(51) Int. Cl. B41J 2/165

(52) U.S. Cl. 347/33

(57) ABSTRACT

A droplet discharge apparatus, comprising: a droplet discharge head for discharging droplets, an opposing member, facing the droplet discharge head, an applying member which applies, to the opposing member, application liquid having a characteristic of repelling liquid discharged from the droplet discharge head, and a blade which is in contact with the opposing member and cleans the opposing member, the blade having a characteristic of an affinity to the application liquid at least at a contact portion with the opposing member.

### BACKGROUND

1. Technical Field

The present invention relates to a droplet discharge apparatus for cleaning a member on which liquid droplets discharged from a droplet discharge head adhere.

2. Related Art

In an ink jet printer as a droplet discharge apparatus, when a paper jam occurs during printing, sometimes, an ink droplet is discharged from an ink jet recording head (droplet discharge head) while there is no sheet of paper on a conveyer belt (conveyer member), so that ink adheres to the conveyer belt. Also, in a case where dummy jetting, that is, a discharge of an ink droplet which is unrelated to printing, is performed toward the conveyer belt so as to prevent clogging in an unused nozzle, ink adheres to the conveyer belt. Thus, in an ink jet printer, a cleaning member such as a blade or the like is provided, which wipes off the ink adhering to the conveyer belt.

### SUMMARY

According to an aspect of the present invention, there is provided a droplet discharge apparatus, comprising: a droplet discharge head for discharging droplets, an opposing member, facing the droplet discharge head, an applying member which applies, to the opposing member, application liquid having a characteristic of repelling liquid discharged from the droplet discharge head, and a blade which is in contact with the opposing member and cleans the opposing member, the blade having a characteristic of an affinity to the application liquid at least at a contact portion with the opposing member.

### BRIEF DESCRIPTION OF THE DRAWINGS

An exemplary embodiment of the present invention will be described in detail based on the following figures, wherein:

FIG. 1 is a schematic side view showing an ink jet recording apparatus of a first exemplary embodiment of the present invention;

FIG. 2 is a schematic side view showing the ink jet recording apparatus of the first exemplary embodiment of the present invention;

FIG. 3 is a schematic side view showing a printing part of the ink jet recording apparatus of the first exemplary embodiment of the present invention;

FIG. 4 is an enlarged cross sectional view showing a conveyer belt provided in the ink jet recording apparatus of the first exemplary embodiment of the present invention;

FIG. 5 is an enlarged side view showing a blade and the conveyer belt of the ink jet recording apparatus of the first exemplary embodiment of the present invention;

FIG. 6 is a perspective view showing the blade of the ink jet recording apparatus of the first exemplary embodiment of the present invention;

FIG. 7 is a schematic side view showing an ink jet recording apparatus of a second exemplary embodiment of the present invention;

FIG. 8 is a schematic side view showing the ink jet recording apparatus of the second exemplary embodiment of the present invention;

FIG. 9 is a schematic side view showing a printing part of the ink jet recording apparatus of the second exemplary embodiment of the present invention;

FIG. 10 is an enlarged cross sectional view showing a surface of an intermediate transfer drum provided in the ink jet recording apparatus of the second exemplary embodiment of the present invention;

FIG. 11 is an enlarged side view showing a blade and the intermediate transfer drum of the ink jet recording apparatus of the second exemplary embodiment of the present invention;

FIG. 12 is a schematic side view showing a first example of the blade of the ink jet recording apparatus of the first exemplary embodiment of the present invention;

FIG. 13 is a schematic side view showing a second example of the blade of the ink jet recording apparatus of the first exemplary embodiment of the present invention;

FIG. 14 is a schematic side view showing a third example of the blade of the ink jet recording apparatus of the first exemplary embodiment of the present invention; and

FIG. 15 is a schematic side view showing a fourth example of the blade of the ink jet recording apparatus of the first exemplary embodiment of the present invention.

### DETAILED DESCRIPTION

A first exemplary embodiment of the present invention will be described below with reference to the drawings.

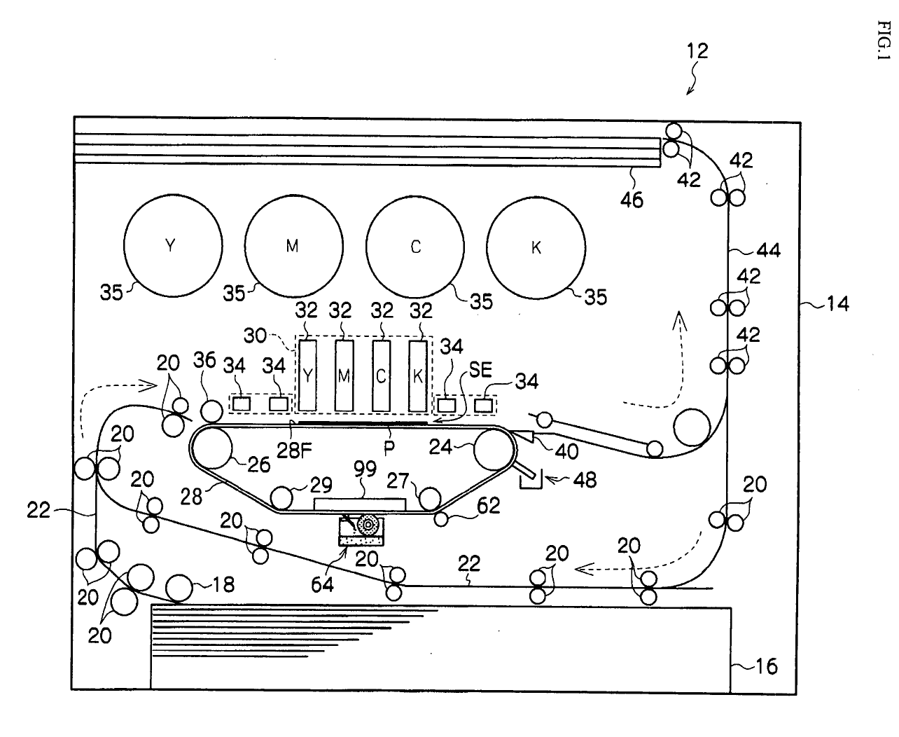

An ink jet recording apparatus 12 as a droplet discharge apparatus of the present exemplary embodiment is shown in FIG. 1. A paper feed tray 16 is provided on a lower portion inside a case body 14 of the ink jet recording apparatus 12, and paper P stacked in the paper feed tray 16 can be taken one by one by a pick up roller 18. The taken paper P is transported by plural pairs of transport rollers 20 constituting a predetermined transport path 22.

An endless conveyer belt 28, as an opposing member and a conveyer member, is stretched across a drive roller 24 and driven rollers 26, 27, 29 above the paper feed tray 16. The drive roller 24 and the driven roller 26 are arranged approximately horizontally, and below these, the driven rollers 27, 29 are arranged approximately horizontally.

A recording head array 30 is arranged above the conveyer belt 28, and faces a flat portion 28F of the conveyer belt 28 which is between the drive roller 24 and the driven roller 26. This facing area corresponds to a discharge area SE where ink droplets are discharged from the recording head array 30. The paper P transported on the transport path 22 is supported by the conveyer belt 28 to reach the discharge area SE, to which ink droplets from the recording head array 30 adhere in accordance with image information in a state in which the paper P faces the recording head array 30.

In the present exemplary embodiment, the recording head array 30 has a long shape whose effective recording area is the width of the paper P or greater (length in the direction perpendicular to the transport direction), and four ink jet recording heads (hereinafter referred to as recording heads) 32 as the droplet discharge heads corresponding to respective four colors of yellow (Y), magenta (M), cyan (S), and black (K) are arranged along the transport direction, enabling a full color image to be recorded.

The respective recording heads 32 are driven by a head drive circuit (not shown). The head drive circuit is for example constructed such that it determines a discharge timing of ink droplets and an ink discharge port (nozzle) to be used in accordance with image information and sends a drive signal to the recording heads 32.

The recording head array 30 may be immovable in the direction perpendicular to the transport direction, or, as the need arises, constructed so as to be movable, for image recording by multipass giving higher resolution image recording, and enabling problems of the recording heads 32 be to be prevented from being reflected in recording results.

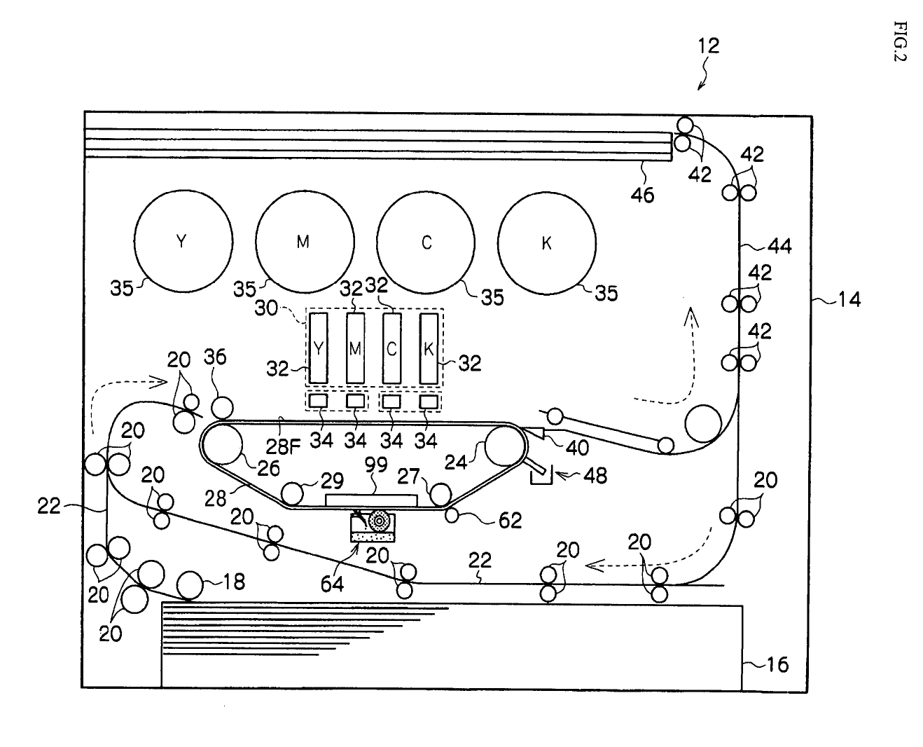

Four maintenance units 34 corresponding to the respective recording heads 32 are arranged at both sides of the recording head array 30. As shown in FIG. 2, when maintenance is performed to the recording heads 32, the recording head array 30 is moved in an upward direction, and the maintenance units 34 are moved and inserted into a gap formed between the recording head array 30 and the conveyer belt 28. In a state in which the maintenance units 34 face nozzle surfaces, predetermined maintenance actions (suction, wiping, capping, and the like) are performed.

Ink tanks 35 storing the inks of the respective colors are arranged above the recording head array 30. The respective recording heads 32 are coupled with the respective ink tanks 35.

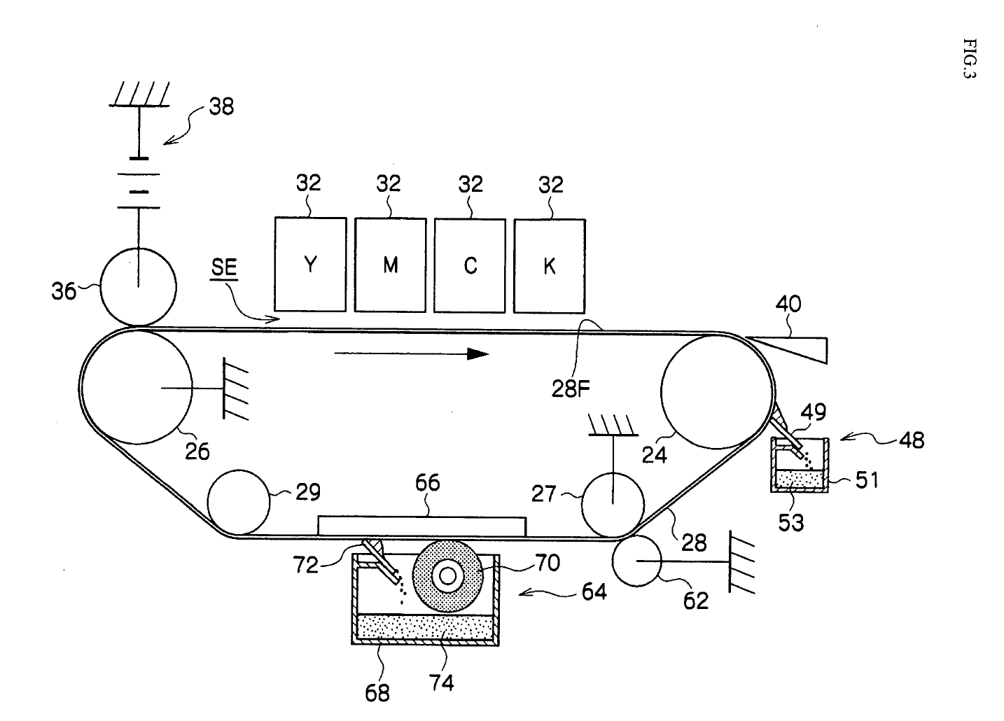

As shown in FIG. 3, a charging roller 36 connected to a power source 38 is disposed upstream of the recording head array 30. The charging roller 36 is driven, with the conveyer belt 28 and the paper P sandwiched between the charging roller 36 and the driven roller 26, and presses the paper P to the conveyer belt 28. At this time, since a predetermined electric potential difference is generated between the charging roller 36 and the grounded driven roller 26, it is possible to give electrical charges to the paper P so that the paper P is electrostatically attracted to the conveyer belt 28.

A separation claw 40 is disposed downstream of the recording head array 30 to separate the paper P from the conveyer belt 28. The separated paper P is transported by plural discharge roller pairs 42 which form a discharge path 44 downstream of the separation claw 40 and is discharged into a paper discharge tray 46 disposed in an upper part of the case body 14.

A belt cleaning unit 48 is arranged under the separation claw 40. The belt cleaning unit 48 has a blade 49 which abuts a portion of the conveyer belt 28 that is wound around the drive roller 24 and which wipes off ink and the like adhering to the conveyer belt 28, and a collection box 51 which collects ink and the like wiped off from the conveyer belt 28 by the blade 49. The entire bottom part of the collection box 51 is covered with an absorption body 53 such that the absorption body 53 absorbs liquid dropping from the blade 49.

A grounded electricity removing roller 62 is arranged downstream of the belt cleaning unit 48. The electricity removing roller 62 is driven, with the conveyer belt 28 sandwiched between the electricity removing roller 62 and the grounded driven roller 27, so that electrical charges on the conveyer belt 28 are removed.

An oil applying unit 64 and a backup plate 66 face each other between the driven roller 26 and the driven roller 27, in either side of the conveyer belt 28. The oil applying unit 64 faces the outer peripheral surface of the conveyer belt 28, and the backup plate 66 abuts the inner peripheral surface of the conveyer belt 28.

The oil applying unit 64 includes a case 68, an oil applying roller 70 as an applying member rotatably supported by the case 68, and an oil blade 72 supported by the case 68. The oil applying roller 70 is pressed against the backup blade 66, sandwiching the conveyer belt 28 therebetween, and rotates, driven by the conveyer belt 28. The oil applying roller 70 is formed of a porous body such as polyethylene, urethane, or the like, and is impregnated with silicone oil to apply the silicone oil to the conveyer belt 28. On the other hand, the ink discharged from the recording head 32 is a water-based ink. Thus, when ink adheres to the conveyer belt 28 due to unplanned ink discharge when there is a paper jam, or due to a dummy jetting discharge to the conveyer belt 28, the ink coagulates due to the water repellent of a silicone oil film on the conveyer belt 28. Accordingly, increase of force by which ink adheres to the conveyer belt 28 can be suppressed, and when the conveyer belt 28 is cleaned by the blade 49, the ink is easily separated from the conveyer belt 28.

Here, since dummy jetting is performed with a short cycle time, that is, one time every ten seconds or the like, in order to prevent an increase of viscosity of the ink inside the recording head 32, it is effective if the silicone oil film is always formed on the conveyer belt 28 as in the present exemplary embodiment.

The oil applying roller 70 may be a driven roller driven by the conveyer belt 28 or may be a drive roller which is rotatably driven by a motor. In this case, the oil applying roller 70 can be prevented from slipping with respect to the conveyer belt 28.

The oil blade 72 abuts the conveyer belt 28 downstream of the oil applying roller 70 in the rotation direction of the conveyer belt 28, and wipes off the excess portion of the silicone oil applied on the conveyer belt 28 to make the thickness of the silicone oil film a predetermined thickness. The oil blade 72 may be made of a rubber such as fluorine rubber, NBR, or the like, or a sheet metal such as SUS or the like, or a resin film such as polyurethane, PET, or the like.

The whole of the bottom part of the case 68 is covered with an absorption member 74 such as sponge or the like, which absorbs silicone oil wiped off from the conveyer belt 28 by the oil blade 72.

The conveyer belt 28 may be formed of a resin such as PET, PI, PA, PC, or the like, or a rubber material such as CR, NBR, HNBR, urethane rubber, or the like, and its surface may be coated. The blade 49 may be formed of a rubber material such as fluorine rubber, NBR, HNBR, or the like, or a sheet metal such as SUS or the like, or a film formed of a resin such as polyurethane, PET, or the like. Although nonwoven fabric formed of polyester, polyamide, or the like is preferred for the roller part of the oil applying roller 70, it may be another material as long as it can absorb a certain amount of ink and is windable.

As liquid applied to the conveyer belt 28 by the oil applying roller 70 (hereinafter referred to as application liquid), silicone oil is used as described above, and a water-based ink is used as ink. Here, as the application liquid, a liquid which repels ink is preferred, and when a water-based ink is a water repellent liquid other than silicone oil such as higher fatty acid such as oleic acid, linoleic acid, and the like, plasticizer such as phthalic acid dibutyl, phthalic acid diisodecyl, maleic acid dibutyl, and the like, alcohols which are insoluble in water such as n-decanol, dimethyl butanol, and the like, fluorine oil, mineral oil, or plant oil may be employed. Further, a liquid with high oil repellency such as water may be employed when an oil-based ink is used.

In order to stabilize application of the application liquid to the conveyer belt 28, a preferred kinematic viscosity of the application liquid is in the range of from 10 to 10⁴ mm²/s, and a more preferred kinematic viscosity is in the range of from 50 to 10² mm²/s.

When the application thickness of the application liquid is too thick, oil penetrates the paper P so that the paper P repels ink, and thus there is a possibility that the image quality is adversely affected. On the other hand, when the application thickness of the application liquid is too thin, cleaning for ink by the blade 49 is not appropriately performed. Thus, it is necessary to set the application thickness of the application liquid to an appropriate range. A preferred range of the application thickness of the application liquid is 1 nm to 20 μm.

The application liquid is needed to be non-volatile at room temperature. Specifically, the vapor pressure is 13.33 Pa or less at 25° C. Further, the application liquid is needed to be incompatible with ink. Specifically, the solubility thereof in the ink is 0.1 wt % or less at room temperature (25° C.).

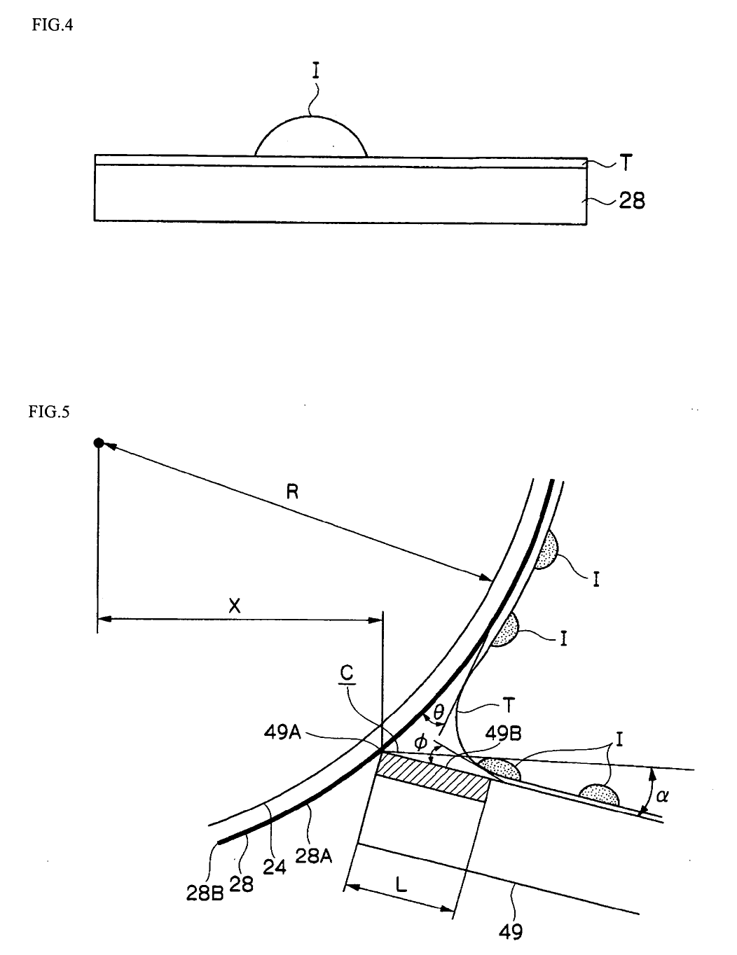

Since the application liquid needs to wet, and spread out over the conveyer belt 28, the relationship of the following equation (A) is necessary. Here, as shown in FIG. 4, the surface tension of the application liquid T is γ₀ and the critical surface tension of the conveyer belt 28 T is γ_{b}. The critical surface tension corresponds to the surface tension of when cosine θ is corrected to 1 (that is, contact angle of liquid with respect to solid body surface becomes 0°) in the relationship between surface tensions of various liquids and contact angles θ of solid bodies. In general, a solid body is excellently wet with a liquid that has a surface tension less than the critical surface tension that the surface has.

γ₀<γ_{b} (A)

In order to let the application liquid T have water repellency, the relationship of the following equation (B) is necessary. Here, the surface tension of ink I is γᵢ.

γ₀<γᵢ (B)

Thus, the ink I coagulates without wetting and spreading out over the film of the application liquid T. An experiment is conducted to evaluate a cleaning performance where the conveyer belt 28 is a belt of PET having the critical surface tension γ_{b} of about 43 [mN/m], the application liquid is a silicone oil having the surface tension γ₀ of about 20 [mN/m], and the ink is a water-based ink having the surface tension γᵢ of about 30 [mN/m]. As the result, residue of the ink does not exist on the conveyer belt 28, and the cleaning performance is excellent.

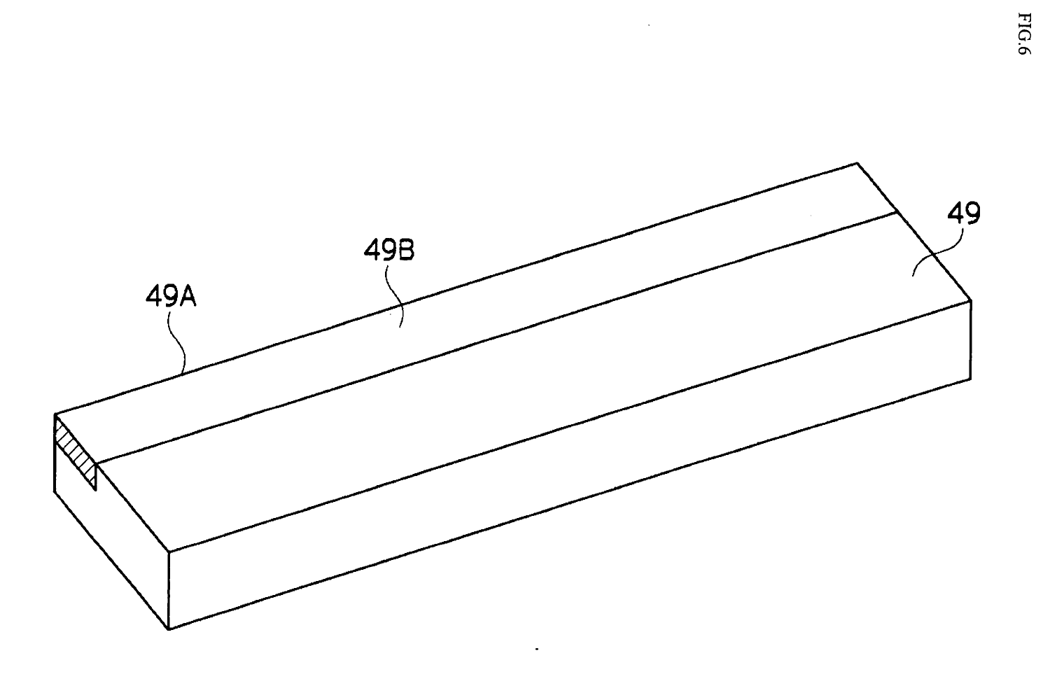

As shown in FIG. 5, the blade 49 is a rectangular-shaped plate material, and an entire angled portion (edge) 49A being one end portion in the width direction contacts with the outer peripheral surface 28A of the conveyer belt 28 to wipe off the ink I and the application liquid T adhering to the conveyer belt 28. The blade 49 is disposed such that the other end side thereof in the width direction includes downwards a predetermined angle α (<90°). Thus, the ink I and the application liquid T wiped off from the conveyer belt 28 by the edge 49A of the blade 49 flow toward the other end side of the blade 49 in the width direction thereof due to their weights and fall into the collection box 51 from the other side end portion of the blade 49 in the width direction thereof.

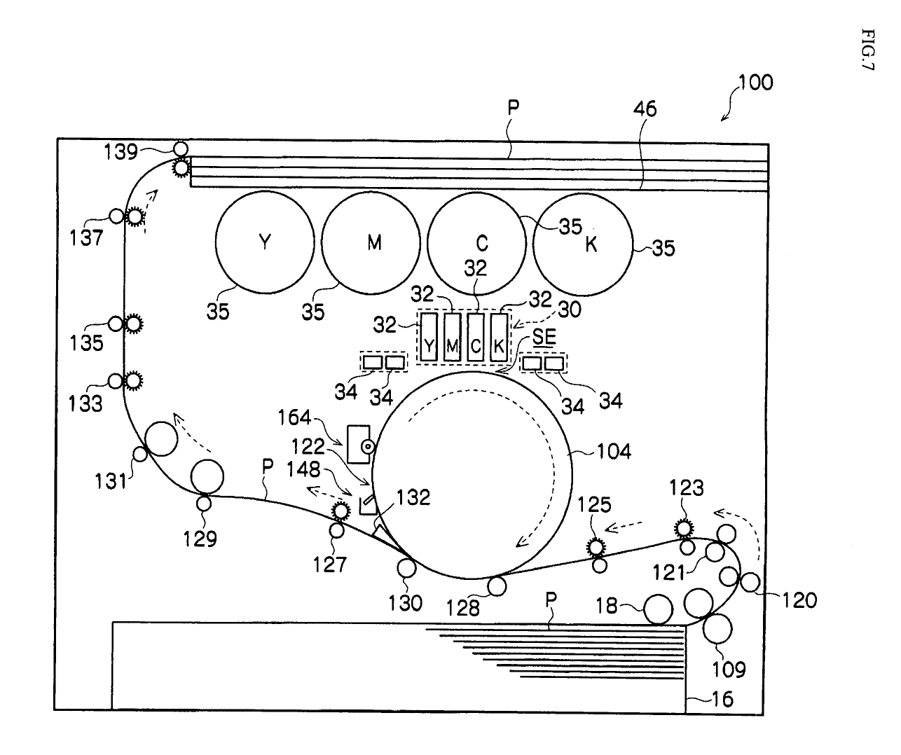

Here, as shown in FIGS. 5 and 6, a lipophilic coating layer 49B is formed on one end portion of a surface of the blade 49 in the width direction thereof which is at the upstream side in the rotation direction of the conveyer belt 28, along the edge 49A being in contact with the conveyer belt 28. On the other hand, since the application liquid T is silicone oil that is oil-based oil, as shown in FIG. 5, the application liquid T wiped off from the conveyer belt 28 by the edge 49A of the blade 49 can form a stable application liquid layer on the edge 49A.

Thus, a film of the application liquid T is formed on the edge 49A of the blade 49, and the ink I wiped off from the conveyer belt 28 by the edge 49A of the blade coagulates on the edge 49A of the blade 49. Accordingly, compared to conventionally, the ink I can be prevented from accumulating on the edge 49A of the blade 49, and defective cleaning of the conveyer belt 28 by the blade 49 can be prevented.

Here, the lipophilic coating layer 49B can be formed by coating silicone resin or by printing with silicone oil. The silicone resin and silicone oil may be mixed with lipophilic smectite, hexane, Cell Sorb, or the like.

A lipophilic coating layer 28B is formed on the outer peripheral surface 28A of the conveyer belt 28, and the application liquid T applied to the conveyer belt 28 by the applying roller 70 can form a stable application liquid layer on the outer peripheral surface 28A of the conveyer belt 28. Thus, since the amount of the application liquid T of an angled portion C formed by the outer peripheral surface 28A of the conveyer belt 28 and the coating layer 49B of the blade 49 is increased, the ink I can be prevented from accumulating on the edge portion 49A of the blade 49, compared to conventionally.

The required minimum of the width L of the coating layer 49B of the blade 49 is determined by the radius R of the drive roller 24, the distance X in the horizontal direction from the center of the drive roller 24 to the edge 49A, the above-described predetermined angle α that is the contact angle between the blade 49 and the conveyer belt 28, the contact angle φ between the application liquid T and the blade 49, and the contact angle θ between the application liquid T and the conveyer belt 28. In the present exemplary embodiment, the radius R is 25 mm, the distance X is 12.5 mm, the predetermined angle α is 30°, the contact angle φ is nearly 0°, the contact angle θ is nearly 0°, and the required minimum of the width L is 3.22 mm.

Next, a second exemplary embodiment of the present invention will be described. The structures similar to those in the first exemplary embodiment will have the same reference numerals, and description thereof will be omitted.

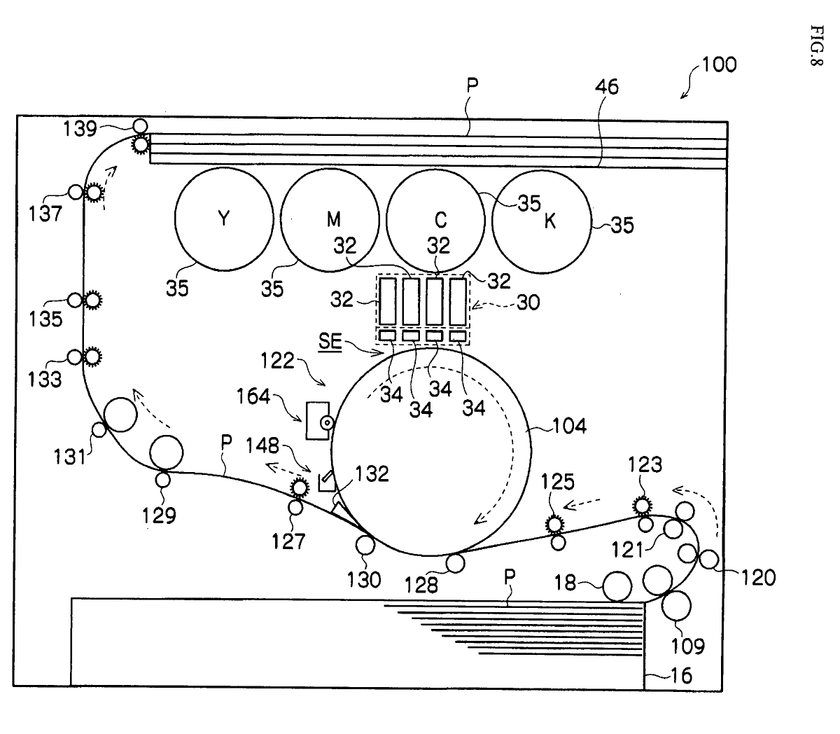

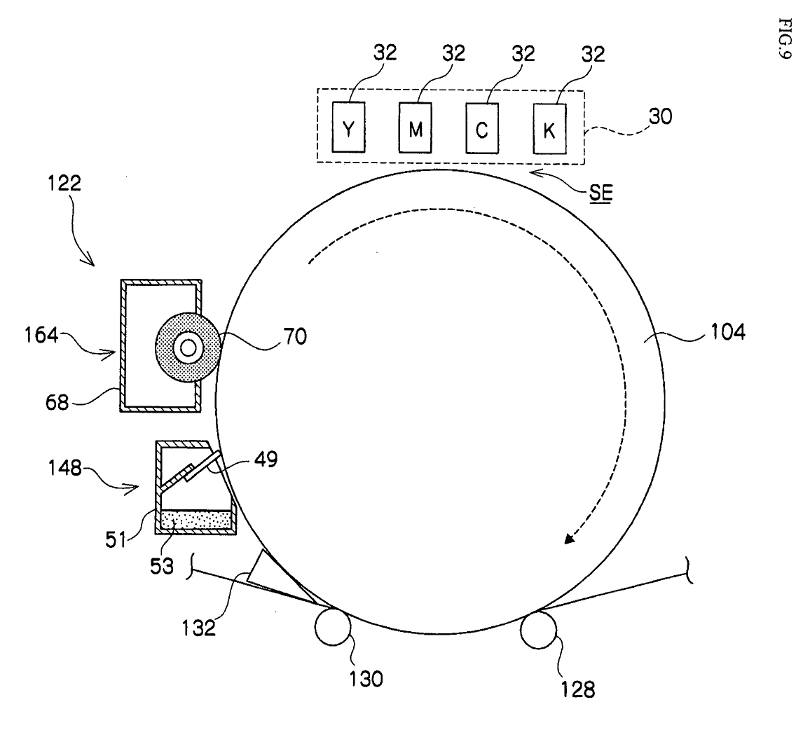

As shown in FIGS. 7 and 8, an ink jet recording apparatus 100 as a droplet discharge apparatus of the present exemplary embodiment is a full color printer in which a full color image is formed on the paper P with four colors of inks of yellow (Y), magenta (M), black (K), and cyan (C). The ink jet recording apparatus 100 is a printer using a so-called offset printing method, and the recording head array 30 discharges ink toward an intermediate transfer drum 104 as an opposing member and a holding body to tentatively form an ink image on the intermediate transfer drum 104, and to transfer the ink image on the paper P from the intermediate transfer drum 104.

The paper feed tray 16 is provided in an insertable/extractable manner on a lowest portion of the ink jet recording apparatus 100. The paper P is stacked and placed on the paper feed tray 16, and the pick up roller 18 abuts an uppermost portion of the paper P. The paper P is fed from the paper feed tray 16 to a downstream portion in the transport direction one by one by the pick up roller 18, and is transported to an image forming part 122 by transport rollers 109, 120, 121, 123, 125 arranged in this order along the transport path. In the transport rollers 123, 125, the rollers which abut the surface on which the ink image of the paper P is transferred are star wheels.

In the image forming part 122, the intermediate transfer drum 104 is disposed while facing the transport path, the recording head array 30 is arranged over the intermediate transfer drum 104, and the maintenance units 34 are located adjacent to the recording head array 30.

As shown in FIG. 7, the recording head array 30 approaches the intermediate transfer drum 104 at the time of discharging ink. As shown in FIG. 8, the recording head array 30 is withdrawn from the intermediate transfer drum 104 at the time of maintenance to ensure a space between itself and the intermediate transfer drum 104, to which the maintenance units 34 are inserted.

As shown in FIG. 7, at the time of image formation, the maintenance units 34 are retracted to outside of the discharge area SE to which ink droplets are discharged from the recording head array 30. As shown in FIG. 8, the maintenance units 34 enter the discharge area SE when no image is formed.

As shown in FIGS. 7 and 8, a charge roller 128 as a transfer part, a charge removal roller 130 as a transfer part, and a separation claw 132 successively from the upstream side in the transport direction abut the transport path side of the intermediate transfer drum 104. The charge roller 128 transports the paper P, pressing it against the intermediate transfer drum 104, and gives electrical charges to the paper P so that the paper P is electrostatically attracted to the intermediate transfer drum 104 and that the ink image is transferred to the paper P. The charge removal roller 130 removes electrical charge of the paper P while transporting it so as to release the electrostatic attraction between the paper P and the intermediate transfer drum 104. The separation claw 132 separates the paper P from the intermediate transfer drum 104.

In the downstream side of the separation claw 132 in the transport direction, transport rollers 127, 129, 131, 133, 135, 137, 139 are arranged successively from the upstream side in the transport direction. In the transport rollers 127, 133, 135, 137, 139, rollers which abut the surface on which the ink image of the paper P is transferred are star wheels, and the contacts between the surface on which the ink image of the paper P is transferred and the rollers are reduced.

The paper discharge tray 46 is disposed above the ink tanks 35, and transport rollers 139 are disposed at a side of the paper discharge tray 46. That is, the paper P is discharged over the paper discharge tray 46 by the transport rollers 139.

As shown in FIG. 9, a drum cleaning unit 148 is arranged downstream of the separation claw 132 in the rotation direction of the intermediate transfer drum 104, and upstream of the recording head array 30 in the rotation direction of the intermediate transfer drum 104. The drum cleaning unit 148 abuts the peripheral surface of the intermediate transfer drum 104 and includes the blade 49 for wiping off ink and the like which has not been transferred to the paper P but has remained on the intermediate transfer drum 104 and the collection box 51 collecting ink and the like wiped off from the intermediate transfer drum 104 by the blade 49. The whole of the bottom part of the collection box 51 is covered with the absorption body 53 such that the body 53 absorbs liquid dropping from the blade 49.

An oil applying unit 164 is disposed downstream of the blade 49 in the rotation direction of the intermediate transfer drum 104, and upstream of the recording head array 30 in the rotation direction of the intermediate transfer drum 104. The oil applying unit 164 includes the case 68 and the oil applying roller 70 rotatably supported by the case 68. The oil applying roller 70 is pressed against the intermediate transfer drum 104 and rotates, being driven by the intermediate transfer drum 104. The oil applying roller 70 is formed of a porous body such as polyurethane, urethane, or the like, and is impregnated with silicone oil to apply the silicone oil to the intermediate transfer drum 104. On the other hand, the ink discharged from the recording heads 32 is a water-based ink. Thus, the ink coagulates due to water repellent effect of the silicone oil film on the intermediate transfer drum 104. Accordingly, increase of the force by which the ink adheres to the intermediate transfer drum 104 can be restrained, and when the intermediate transfer drum 104 is cleaned by the blade 49, the ink is easily separated from the intermediate transfer drum 104.

The oil applying roller 70 may be a drive roller. In this case, the oil applying roller 70 can be prevented from slipping with respect to the intermediate transfer drum 104.

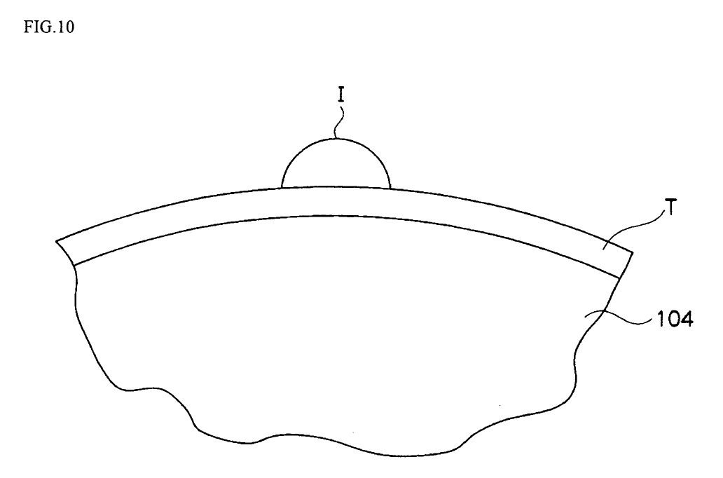

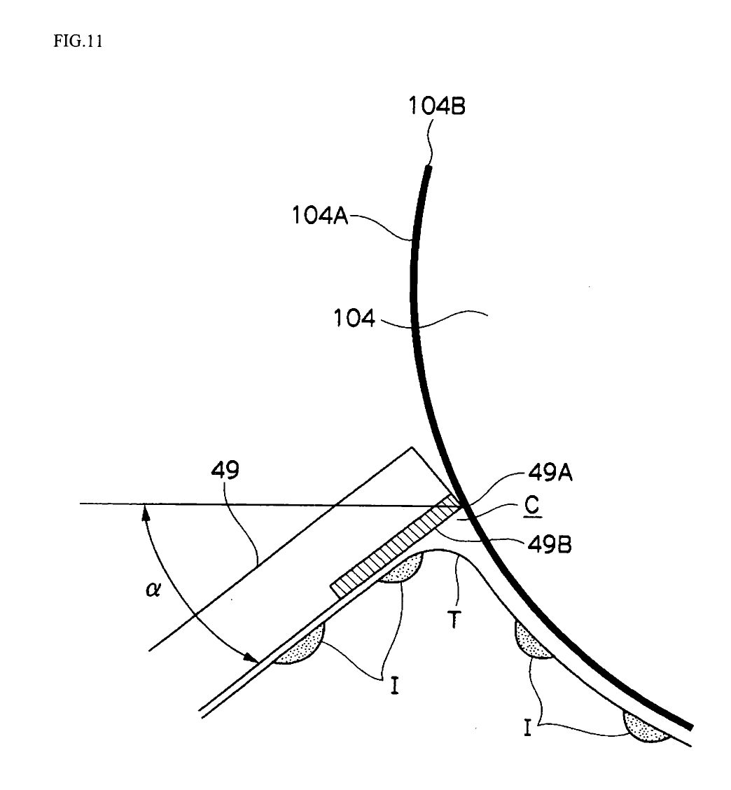

Here, the application liquid is needed to wet and spread out over the intermediate transfer drum 104, the relationship of the following equation (A) is necessary. Here, as shown in FIG. 10, the surface tension of the application liquid T is γ₀ and the critical surface tension of the intermediate transfer drum 104 is γ_{b}.

γ₀<γ_{b} (A)

In order to let the application liquid have water repellency, the relationship of the following equation (B) is necessary. Here, the surface tension of ink I is γᵢ.

γ₀<γᵢ (B)

Thus, since the ink I coagulates without wetting and spreading out over the film of the application liquid T, similarly to the first exemplary embodiment, the ink on the intermediate transfer drum 104 can be easily wiped off by the blade 49.

As shown in FIG. 11, the blade 49 is a rectangular-shaped plate material, and the entire angled portion (edge) 49A being one end portion in the width direction contacts with an outer peripheral surface 104A of the intermediate transfer drum 104 to wipe off the ink I and the application liquid T adhering to the intermediate transfer drum 104. The blade 49 is disposed such that the other end side thereof in the width direction includes downwards a predetermined angle α (<90°). Thus, the ink I and the application liquid T wiped off from the intermediate transfer drum 104 by the edge 49A of the blade 49 flow toward the other end side of the width direction of the blade 49 due to their dead weights to fall to the collection box 51 from the other side end portion in the width direction of the blade 49.

Here, a lipophilic coating layer 49B is formed on one end portion in the width direction of a surface of the blade 49 which is in the upstream side in the rotation direction of the intermediate transfer drum 104, along the edge 49A being in contact with the intermediate transfer drum 104. Since the application liquid T is silicone oil that is oil-based oil, the application liquid T wiped off from the intermediate transfer drum 104 by the edge 49A of the blade 49 can form a stable application liquid layer on the coating layer 49B.

Thus, a film of the application liquid T is formed on the edge 49A of the blade 49, and the ink I wiped off from the intermediate transfer drum 104 by the edge 49A of the blade 49 coagulates on the edge 49A of the blade 49. Accordingly, compared to conventionally, the ink I can be prevented from accumulating on the edge 49A of the blade 49, and defective cleaning of the intermediate transfer drum 104 by the blade 49 can be prevented.

Here, a lipophilic coating layer 104B is formed on the outer peripheral surface 104A of the intermediate transfer drum 104, and the application liquid T applied to the intermediate transfer drum 104 by the oil applying roller 70 can form a stable application liquid layer on the outer peripheral surface 104A of the intermediate transfer drum 104. Thus, since the amount of the application liquid T of an angled portion C formed by the outer peripheral surface 104A of the intermediate transfer drum 104 and the coating layer 49B of the blade 49 is increased, the ink I can be prevented from accumulating on the edge portion 49A of the blade 49, compared to conventionally.

Next, examples of the blade 49 will be described.

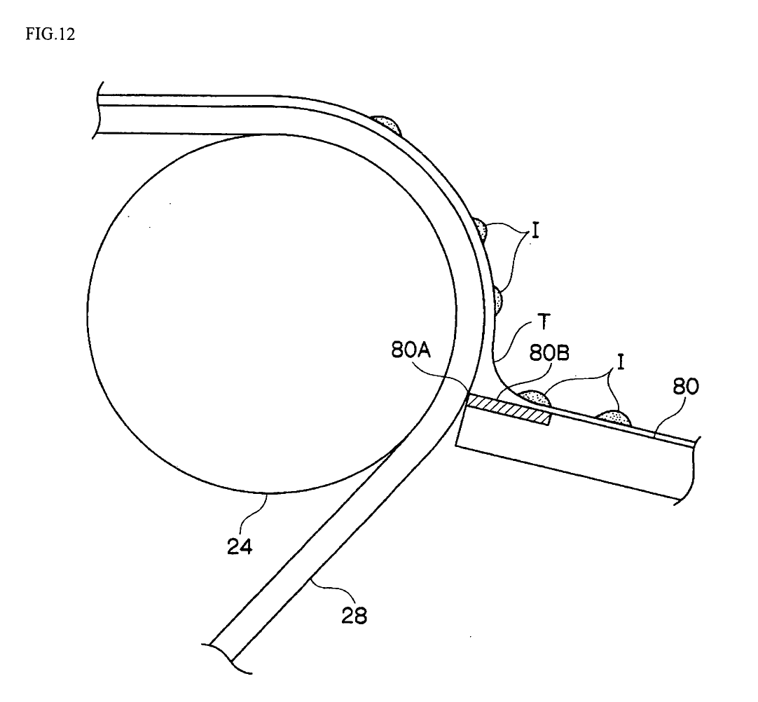

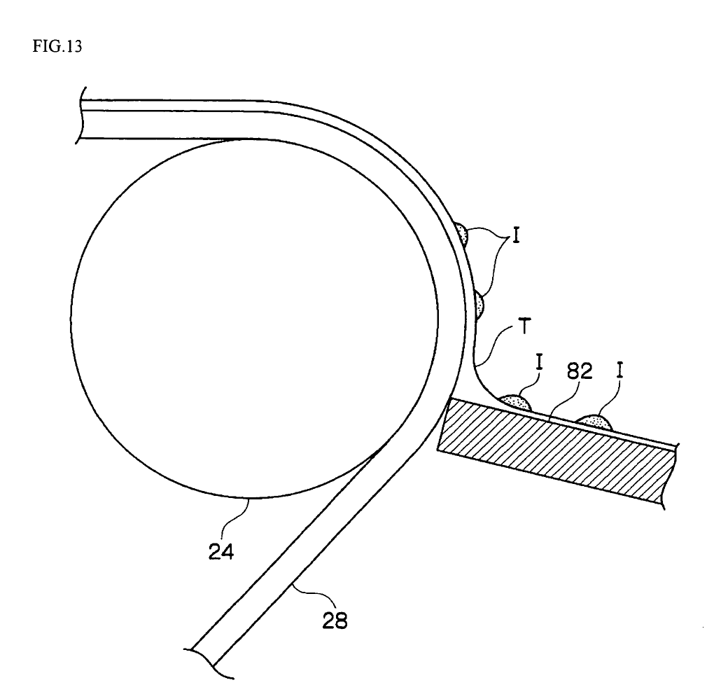

As shown in FIG. 12, in a blade 80 of a first example, a lipophilic portion 80B having lipophilicity is formed on one end portion of the conveyer belt 28 side of a surface at the upstream side of the rotation direction of the conveyer belt 28, along an edge 80A that contacts the conveyer belt 28. Thus, the application liquid T wiped off from the conveyer belt 28 by the edge 80A of the blade 80 can form a stable application liquid layer on the edge 80A.

Here, the lipophilic portion 80B can be formed in such a way that the periphery of the edge 80A of the blade 80 is impregnated with liquid having lipophilicity such as silicone oil KF 96 (Trade name, manufactured by Shin-Etsu Chemical Co., Ltd.) or the like. In addition, the lipophilic portion 80B may be formed of a lipophilic member such as silicone resin or the like.

As shown in FIG. 13, a blade 82 of a second example is formed of a lipophilic member. Thus, a film of the application liquid T is formed on the entire surface of the blade, which is at the upstream side in the rotation direction of the conveyer belt 28, and a water-based ink I is hard to adhere thereto. Accordingly, compared to the prior art, the ink I wiped off from the conveyer belt 28 by an edge 82A of the blade 82 can be prevented from remaining on the blade 82. Specifically, as the contact angle of water with respect to an oil-based oil such as silicone oil or the like is 90-110°, the oil-based oil has a high water repellency, therefore, an excellent effect can be produced by setting the application liquid T to be an oil-based oil.

Here, the blade 82 can be formed of a lipophilic material such as silicone oil resin or the like. The blade 82 may be formed by impregnating an entire plate material made of rubber, resin, or the like, with lipophilic liquid such as silicone oil KF 96 (Trade name, manufactured by Shin-Etsu Chemical Co., Ltd.) or the like.

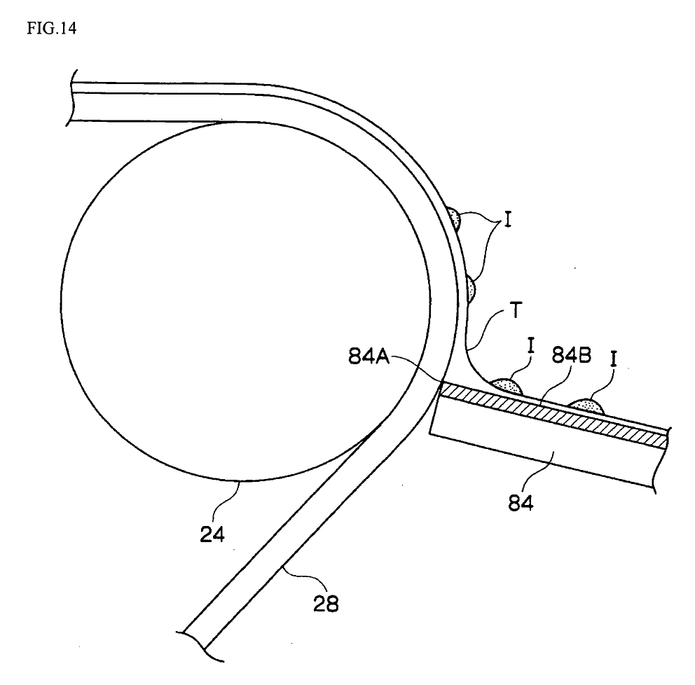

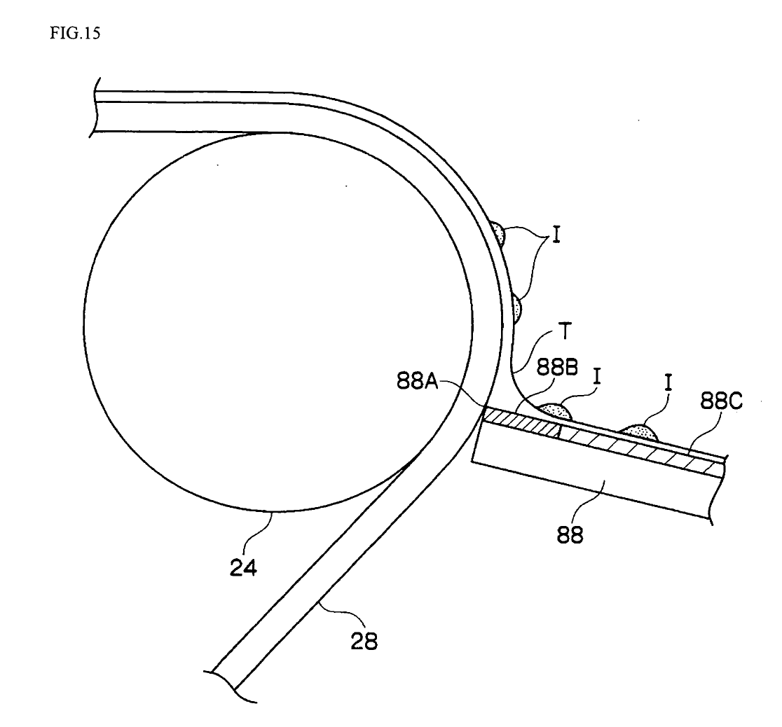

As shown in FIG. 14, in a blade 84 of a third example, a lipophilic portion 84B with lipophilicity is formed on an entire surface which is at the upstream side in the rotation direction of the conveyer belt 28. Thus, a film of the application liquid T is formed on the entire surface of the blade 84, which is at the upstream side in the rotation direction of the conveyer belt 28, and the water-based ink I is hard to adhere thereto. Accordingly, compared to the prior part, the ink I wiped off from the conveyer belt 28 by an edge 84A of the blade 84 is prevented from remaining on the blade 84.

Here, the lipophilic portion 84B can be formed in such a way that one surface of the blade 84 is impregnating with the liquid having lipophilicity such as silicone oil KF 96 (Trade name, manufactured by Shin-Etsu Chemical Co., Ltd.) or the like, or that one surface of the blade 84 is coated with resin having lipophilicity such as silicone resin or the like.

As shown in FIG. 15, in a blade 88 of a fourth example, a lipophilic portion 88B having lipophilicity is formed on one end portion of the conveyer belt 28 side of a surface which is at the upstream side in the rotation direction of the conveyer belt 28, along an edge 88A that contacts the conveyer belt 28. On the surface of the blade 88 on which the lipophilic portion 88B is formed, at a part at which the lipophilic portion 88B is not formed, a water repellent portion 88C having a property of repelling the water-based ink I, that is, water repellency is formed. Thus, the ink I is hard to adhere to the entire surface of the blade 88 which is at the upstream side in the rotation direction of the conveyer belt 28. Accordingly, the ink I wiped off from the conveyer belt 28 by the edge 88A of the blade 88 is prevented from remaining on the blade 88.

Here, the lipophilic portion 88B can be formed in such a way that a part of the blade 88 is impregnated with the liquid having lipophilicity such as silicone oil KF 96 (Trade name, manufactured by Shin-Etsu Chemical Co., Ltd.) or the like, or that a part of the blade 88 is coated with resin having lipophilicity such as silicone resin or the like. The water repellent portion 88C can be formed in such a way that a part of the blade 88 is coated with a material having water repellency such as fluorine resin or the like.

In the first and second exemplary embodiments, although an ink jet recording apparatus is adopted as an example to describe the present invention, the present invention is not limited to an ink jet recording apparatus and can be applied to a droplet discharge apparatus in general, for various industrial uses such as manufacture of a color filter for a display in which colored ink is discharged on a polymer film, or formation of an EL display panel in which an organic EL solution is discharged on a substrate.

The “recording medium” on which image recording is performed in a droplet discharge apparatus of the present invention includes a wide variety of products as long as a droplet discharge head is to discharge droplets on them. Accordingly, the recording medium includes recording paper, OHP sheet and the like, of course, and besides, includes a polymer film and the like, for example.

The “droplet discharge head” in a droplet discharge apparatus of the present invention includes a wide variety of products as long as they are the members that discharge droplets toward a recording medium, a support body and the like. For example, it includes an ink jet recording head and the like which has a shorter width than the width of the paper P and which discharges ink droplets while moving in the width direction of the paper P.

The “opposing member” in a droplet discharge apparatus of the present invention includes a wide variety of products as long as they are the members to face the droplet discharge head. For example, it includes a drum which holds the recording medium on its peripheral surface to rotate, a belt which carries droplets to rotate, and the like.

The “transport member” in a droplet discharge apparatus of the present invention includes a wide variety of products as long as they are the members to hold the recording medium to transport. For example, it includes a drum which holds the recording medium on its peripheral surface to rotate, a reciprocating table which holds the recording medium, and the like.

The “holding body” in a droplet discharge apparatus of the present invention includes a wide variety of products as long as they are the members to hold liquid discharged from the droplet discharge head. For example, it includes a belt and the like which holds a liquid and rotates.

The “applying member” in a droplet discharge apparatus of the present invention includes a wide variety of products as long as they are the members to apply to the transport member the application liquid which has a characteristic of repelling droplets discharged from the droplet discharge head. For example, it includes a droplet discharge head which discharges the application liquid toward the transport member, a web which is impregnated with the application liquid and which is in contact with the transfer member, a roller which holds the application liquid on its surface and which is in contact with the transfer member and rotates, a roller which is impregnated with the application liquid or holds the application liquid on its surface and which is in contact with the transfer member and moves in a direction perpendicular to the transport direction, and the like.

The foregoing descriptions of the exemplary embodiments of the present invention have been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A droplet discharge apparatus, comprising:
a droplet discharge head for discharging droplets;
an opposing member, facing the droplet discharge head;
an applying member which applies, to the opposing member, application liquid having a characteristic of repelling liquid discharged from the droplet discharge head; and
a blade which is in contact with the opposing member and cleans the opposing member, the blade having a characteristic of an affinity to the application liquid at least at a contact portion with the opposing member.

2. The droplet discharge apparatus of claim 1, wherein at least the contact portion of the blade with the opposing member is formed of a material with a characteristic of an affinity to the application liquid.

3. The droplet discharge apparatus of claim 1, wherein at least on the contact portion of the blade with the opposing member, a coating layer with a characteristic of an affinity to the application liquid is formed.

4. The droplet discharge apparatus of claim 1, wherein at least a surface of the opposing member contacting with the blade has a characteristic of an affinity to the application liquid.

5. The droplet discharge apparatus of claim 1, wherein the opposing member is a transport member which holds and transports a recording medium, with the recording medium facing the droplet discharge head.

6. The droplet discharge apparatus of claim 1, wherein the opposing member is a holding body which holds droplets discharged from the droplet discharge head, and includes a transfer portion for transferring the droplets from the holding body to the recording medium.

7. A droplet discharge apparatus, comprising:
a droplet discharge head for discharging droplets;
an opposing member, facing the droplet discharge head;
an applying unit, provided with a case and a liquid applying roller rotatably supported on the case and which applies application liquid having a characteristic of repelling liquid discharged from the droplet discharge head to the opposing member; and
a cleaning unit provided with a blade and a collection box collecting matter removed from the opposing member by the blade, and which is in contact with the opposing member to clean the opposing member;
the blade having an affinity to the application liquid at least at a contact portion with the opposing member.

8. The droplet discharge apparatus of claim 7, wherein at least the contact portion of the blade with the opposing member is formed of a material with a characteristic of an affinity to the application liquid.

9. The droplet discharge apparatus of claim 7, wherein at least on the contact portion of the blade with the opposing member, a coating layer with a characteristic of an affinity to the application liquid is formed.

10. The droplet discharge apparatus of claim 7, wherein the opposing member is a transport member which holds and transports a recording medium, with the recording medium facing the droplet discharge head.

11. The droplet discharge apparatus of claim 7, wherein the opposing member is a holding body which holds droplets discharged from the droplet discharge head, and includes a transfer portion for transferring the droplets from the holding body to the recording medium.
